(19) United States
(12) Patent Application Publication
(10) Pub. No.: US 2016/0292364 A1
(43) Pub. Date: Oct. 6, 2016

(54) DISPLAY CONTROL METHOD, INFORMATION PROCESSING APPARATUS, AND COMPUTER-READABLE RECORDING MEDIUM

(71) Applicant: FUJITSU LIMITED, Kawasaki-shi (JP)

(72) Inventor: Takahiro Inoue, Kawasaki (JP)

(21) Appl. No.: 15/083,871

(22) Filed: Mar. 29, 2016

(30) Foreign Application Priority Data
Mar. 31, 2015 (JP) 2015-072012

(51) Int. Cl. G06F 19/00; G06F 3/0481

(52) U.S. Cl. CPC G06F 19/322; G06F 19/3406; G06F 3/0481

(57) ABSTRACT

A non-transitory computer-readable recording medium stores a display control program that causes a computer to execute a process including: accepting a command to present medical record information of a patient; and presenting name information of the patient in a window for a predetermined time period, in a layer positioned in front of a layer having a window presenting the medical record information of the patient, in a multi-window system.

### CROSS-REFERENCE TO RELATED APPLICATION

This application is based upon and claims the benefit of priority of the prior Japanese Patent Application No. 2015-072012, filed on Mar. 31, 2015, the entire contents of which are incorporated herein by reference.

### FIELD

The embodiments discussed herein are related to a display control method, an information processing apparatus, and a computer-readable recording medium.

### BACKGROUND

Having been practiced recently in electronic medical record systems is use of a plurality of windows presenting medical record information of patients. A calendar and a piece of medical record content, for example, are presented in the windows. A physician enters the result of his/her examination to a window presenting medical record content. Related art examples are disclosed in Japanese Laid-open Patent Publication No. 05-324604, Japanese Laid-open Patent Publication No. 2001-245038, and Japanese Laid-open Patent Publication No. 2005-020070.

A physician may, however, enter information erroneously to a piece of medical record information belonging to a different patient. For example, a physician may examine a patient, and then switch the window and enter the test information of another patient who has undergone some test. In such a situation, the physician may enter the test information erroneously to the medical record information belonging to a different patient.

### SUMMARY

According to an aspect of the embodiments, a non-transitory computer-readable recording medium stores a display control program that causes a computer to execute a process including: accepting a command to present medical record information of a patient; and presenting name information of the patient in a window for a predetermined time period, in a layer positioned in front of a layer having a window presenting the medical record information of the patient, in a multi-window system.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary configuration of an electronic medical record system according to an embodiment of the present invention;

FIG. 2 is a schematic illustrating an example of a medical record storage unit;

FIG. 3 is a schematic illustrating an example of a patient list screen;

FIG. 4 is a schematic illustrating an example of a confirmation screen;

FIG. 5 is a schematic illustrating examples of a medical record screen and a name display screen;

FIG. 6 is a schematic illustrating another example of the medical record screen;

FIG. 7 is a schematic illustrating other examples of the medical record screen and the name display screen;

FIG. 8 is a schematic illustrating another example of the medical record screen;

FIG. 9 is a flowchart illustrating an example of a display control process according to the embodiment; and

FIG. 10 is a schematic illustrating an example of a computer executing a display control program.

### DESCRIPTION OF EMBODIMENTS

Preferred embodiments will be explained with reference to accompanying drawings. The embodiment, however, is not intended to limit the scope of the technology according to the present invention. The embodiment described below may be combined as appropriate within the scope in which such a combination is not contradictory.

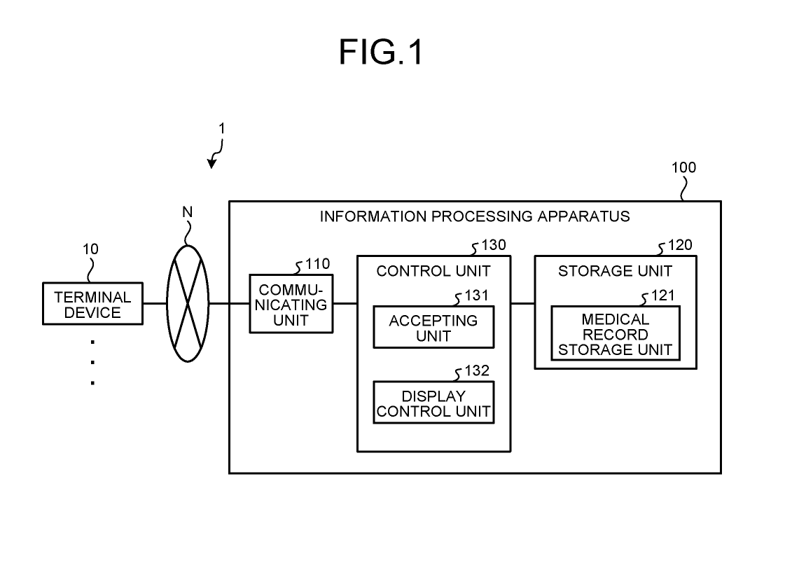

FIG. 1 is a block diagram illustrating an exemplary configuration of an electronic medical record system according to an embodiment of the present invention. An electronic medical record system 1 illustrated in FIG. 1 includes a terminal device 10 and an information processing apparatus 100. Although illustrated in FIG. 1 is an example in which the system has one terminal device 10, the number of the terminal devices 10 is not limited to one, and the electronic medical record system 1 may have any number of terminal devices 10. Hereunder, a transmission and a reception of screen data are simply referred to as a transmissions and a reception of a screen.

The terminal device 10 and the information processing apparatus 100 are connected to each other communicatively over a network N. As the network N, any type of a communication network may be used, regardless whether the network is a wired or a wireless network, including the Internet, a local area network (LAN), and a virtual private network (VPN).

The information processing apparatus 100 receives and accepts a command to present medical record information of a patient from the terminal device 10. Once the information processing apparatus 100 accepts the command, the information processing apparatus 100 presents the medical record information of the patient in a window, and also generates a display screen for displaying, for a predetermined time period, a window presenting the name information of the patient, in a layer positioned in front of the layer having the window presenting the medical record information. The information processing apparatus 100 then transmits the generated display screen to the terminal device 10, and causes the terminal device 10 to display the display screen. In other words, when the command is received, the information processing apparatus 100 presents the name information of the patient for the predetermined time period, in a window belonging to a front layer, being front with respect to the layer of the window presenting the medical record information of the patient, in the multi-window system. In this manner, the information processing apparatus 100 can prevent erroneous input of medical record information belonging to a different patient.

The terminal device 10 is a computer allowing a physician, for example, who is a user of the electronic medical record system 1, to enter and to view electronic medical records. The terminal device 10 presents electronic medical records received from the information processing apparatus 100 by displaying various screens or the like. The terminal device 10 may use a Web browser, for example, for displaying and operating the various screens. The terminal device 10 transmits a command to present a medical record and various types of operation information to the information processing apparatus 100. The terminal device 10 receives a medical record screen, a patient list screen, a confirmation screen, and a name display screen from the information processing apparatus 100, and presents these screens on a display unit not illustrated. A portable personal computer may be used as the terminal device 10, as an example. In addition to a portable terminal, such as the personal computer, a stationary personal computer can be used as the terminal device 10. Other types of mobile communication terminal such as a tablet terminal, a smartphone, a mobile phone, and a personal handyphone system (PHS), may also be used as the portable terminal for the terminal device 10, without limitation to a personal computer.

A configuration of the information processing apparatus 100 will now be explained. As illustrated in FIG. 1, the information processing apparatus 100 includes a communicating unit 110, a storage unit 120, and a control unit 130. The information processing apparatus 100 may also include functional units included in a known computer, e.g., various types of input device or audio output device, in addition to the functional units illustrated in FIG. 1.

The communicating unit 110 is implemented as a network interface card (NIC), for example. The communicating unit 110 is a communication interface establishing a connection with the terminal device 10 over a wire or wirelessly over the network N, and governing the exchange of information with the terminal device 10. The communicating unit 110 receives a command to present a medical record, and operation information from the terminal device 10. The communicating unit 110 outputs the received command to present the medical record, and the received operation information to the control unit 130. The communicating unit 110 also transmits the medical record screen, the patient list screen, the confirmation screen, and the name display screen received from the control unit 130 to the terminal device 10.

The storage unit 120 is implemented as a storage device such as a random access memory (RAM), a semiconductor memory device, e.g., a flash memory, a hard disk, or an optical disc, for example. The storage unit 120 includes a medical record storage unit 121. The storage unit 120 also stores therein information used in the processing performed by the control unit 130.

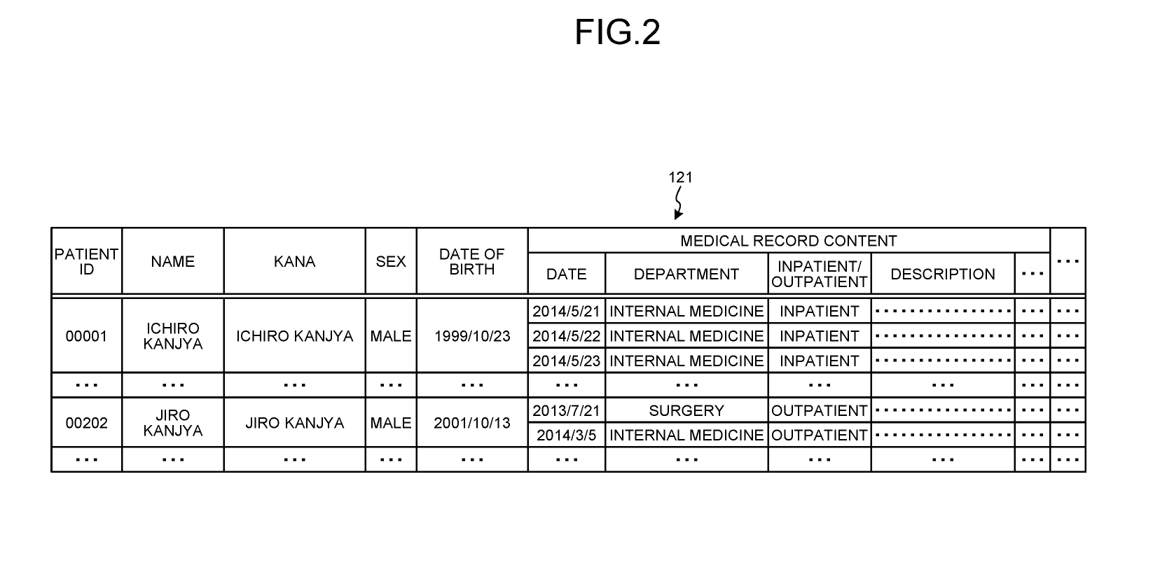

The medical record storage unit 121 stores therein electronic medical records in a manner mapped to patients. FIG. 2 is a schematic illustrating an example of the medical record storage unit. As illustrated in FIG. 2, the medical record storage unit 121 include items such as “patient ID”, “name”, “kana”, “sex”, “date of birth”, and “medical record content”. The “medical record content” includes items such as “date”, “department”, “inpatient/outpatient”, and “description”. The medical record storage unit 121 stores therein a piece of medical record content as a record, for example, and stores therein one or more pieces of medical record content for one patient, in a manner mapped to the patient.

The “patient ID” is an identifier for identifying a patient. The “name” is a piece of information indicating the name of the patient. The “kana” is a piece of information indicating kana (the characters indicating pronunciation of kanji used) for the name of the patient. The “sex” is a piece of information indicating the sex of the patient. The “date of birth” is a piece of information indicating the date of birth of the patient. The “medical record content” is a piece of information indicating the content of the medical record, e.g., an examination or test result of the patient. The “date” included in the medical record content is a piece of information indicating the date on which the medical record content is entered. The “department” included in the medical record content is a piece of information indicating the department responsible for the medical record content. The department may be, for example, internal medicine, surgery, and otorhinolaryngology. The “inpatient/outpatient” included in the medical record content is a piece of information indicating whether the patient corresponding to the medical record content is an inpatient or an outpatient. The “description” included in the medical record content is a piece of information indicating a specific description of the medical record content.

Returning to the explanation of FIG. 1, the control unit 130 is implemented by causing a central processing unit (CPU) or a micro-processing unit (MPU), for example, to execute a computer program stored in an internal storage device using a RAM as a working area. The control unit 130 may also be implemented by an integrated circuit such as an application specific integrated circuit (ASIC) or a field programmable gate array (FPGA). The control unit 130 includes an accepting unit 131 and a display control unit 132, and implements or executes the function or the action of the information processing explained later. The internal configuration of the control unit 130 is not limited to that illustrated in FIG. 1, and may be different configuration as long as such a configuration is capable of performing the information processing explained later.

When the accepting unit 131 receives a piece of operation information for displaying a patient list from the terminal device 10 via the network N and the communicating unit 110, the accepting unit 131 transmits a patient list screen to the terminal device 10 via the communicating unit 110 and the network N. The accepting unit 131 also receives a command to present the medical record of a patient who is selected from the patient list screen from the terminal device 10 via the network N and the communicating unit 110. When the accepting unit 131 receives the command to present the medical record of the selected patient, the accepting unit 131 transmits a confirmation screen to the terminal device 10 via the communicating unit 110 and the network N. When the accepting unit 131 receives operation information for making a confirmation on the confirmation screen from the terminal device 10 via the network N and the communicating unit 110, the accepting unit 131 accepts the command to present the medical record of the selected patient. The accepting unit 131 then outputs the accepted command to present the medical record of the patient to the display control unit 132.

The accepting unit 131 also receives and accepts, when a user selects a patient corresponding to an inactive window in a medical record screen with having medical records of a plurality of respective patients opened, the command to present a medical record of the selected patient from the terminal device 10 via the network N and the communicating unit 110. The accepting unit 131 then outputs the accepted command to present the medical record of the patient to the display control unit 132.

There are some cases in which the accepting unit 131 receives the operation information of a mouse or keyboard operation from the terminal device 10 via the network N and the communicating unit 110, while the name display screen presenting the name information of the patient is being displayed on the terminal device 10. When a piece of operation information is received while the name display screen is being displayed, the accepting unit 131 accepts the operation information as a predetermined command. The accepting unit 131 then outputs the accepted predetermined command to the display control unit 132.

The display control unit 132 determines, when the command to present the medical record of the patient is input from the accepting unit 131, whether the medical record of the patient for whom the command is accepted has already been taken out, based on the patient ID included in the command to present the medical record. If the medical record of the patient for whom the command is accepted has not been taken out yet, the display control unit 132 takes out the medical record of the patient from the medical record storage unit 121, and generates a window of a medical record screen presenting the medical record information of the patient as an operable window. The display control unit 132 transmits the generated medical record screen to the terminal device 10 via the communicating unit 110 and the network N, and displays the medical record screen on the display unit not illustrated. The operable window herein means an active window in the multi-window system. An operable window is also referred to as being operable when the window will be operable after the name display screen window disappears, in a situation in which the name display screen window is displayed in front of the operable window.

If the medical record of the patient for whom the command is accepted has already been taken out, the display control unit 132 updates the window of the medical record screen presenting the medical record information of the patient as an operable window. It is assumed herein that the display control unit 132 has once generated the medical record screen after the medical record is taken out. The display control unit 132 transmits the updated medical record screen to the terminal device 10 via the communicating unit 110 and the network N, and presents the updated medical record screen on the display unit not illustrated.

The display control unit 132 generates a name display screen presenting the name information of the patient corresponding to the operable medical record screen as a separate window, in front of the medical record screen. The patient name information includes the name of the patient and the kana for the patient name. The display control unit 132 then transmits the generated name display screen to the terminal device 10 via the communicating unit 110 and the network N, and presents the name display screen on the display unit not illustrated. In other words, the display control unit 132 presents the name display screen in front of the medical record screen in a superimposed manner. The medical record screen and the name display screen can be displayed in a superimposed manner by using the window layers in the multi-window system, for example. In other words, the display control unit 132 presents the name display screen in the layer in front of the layer in which the medical record screen is displayed. The display control unit 132 may also display the part of the name display screen excluding the part corresponding to the patient name information in a white color at transparency of 50 percent or so, for example, so that users can see the patient name information more easily.

The display control unit 132 may perform display control for displaying the name display screen for a predetermined time period, e.g., 3 seconds, and then starting to cause the name display screen to disappear at the timing at the predetermined time period has elapsed or any other timing subsequent to the timing, and displaying the medical record screen in the frontmost. The display control unit 132 may also perform display control for decreasing the transparency of the name display screen, which is the window presenting the patient name information for a predetermined time period, sequentially from when the name display screen has started being displayed, and starting to increase the transparency after the transparency has reached a predetermined level, e.g., 0 percent. At this time, the display control unit 132 performs the display control for waiting for another predetermined time period (e.g., 3 seconds) from when the predetermined transparency (for example, 0 percent) has been reached to elapse, before starting to increase the transparency of the window, for example.

In other words, the display control unit 132 performs, for the window presenting the patient name information for a predetermined time period, display control for decreasing the transparency of the window, and increasing the transparency after the predetermined transparency has been reached. In this manner, the display control unit 132 can display, when a medical record is selected, the name of the patient corresponding to the medical record and the kana for the patient name in the frontmost, and start causing the name of the patient and the kana for the patient name to disappear after the predetermined time period elapses, for example. Therefore, the possibility of the physician missing out the name information can be reduced.

Alternatively, the display control unit 132 may keep the name display screen displayed until a predetermined command is received from the accepting unit 131. In other words, the display control unit 132 may decrease the transparency of the window of the name display screen sequentially from when the window has started being displayed, and keep displaying the window at the same predetermined transparency until the predetermined time period elapses from when the predetermined transparency is reached, and then the predetermined command is entered. In a situation in which the predetermined command is entered before the predetermined time period elapses, the display control unit 132 keeps displaying the window at the same predetermined transparency until the predetermined time period elapses. The display control unit 132 then causes the window of the name display screen to disappear, by increasing the transparency, at the timing at which the predetermined command is entered after the predetermined time period has elapsed from when the predetermined transparency is reached.

In other words, the display control unit 132 performs the display control for keeping the patient name information being displayed until the predetermined command is accepted, for the window presenting the patient name information for a predetermined time period. In this manner, the display control unit 132 can keep presenting the name of the patient and the kana for the patient name until a user makes a mouse or keyboard operation, for example, therefore, the possibility of the physician missing out the name information can be reduced.

When a user selects a patient whose medical record information is displayed on the medical record screen, the display control unit 132 may display the name display screen presenting the name information of the patient in a manner superimposed over the medical record screen. In other words, the display control unit 132 may control to display the window presenting the patient name information for a predetermined time period, in a manner superimposed over the window presenting the medical record information of the patient. In this manner, the display control unit 132 can display the patient name information of the medical record again, even when the window presenting the medical record information of the patient has already been displayed. The physician can therefore check the patient name information again.

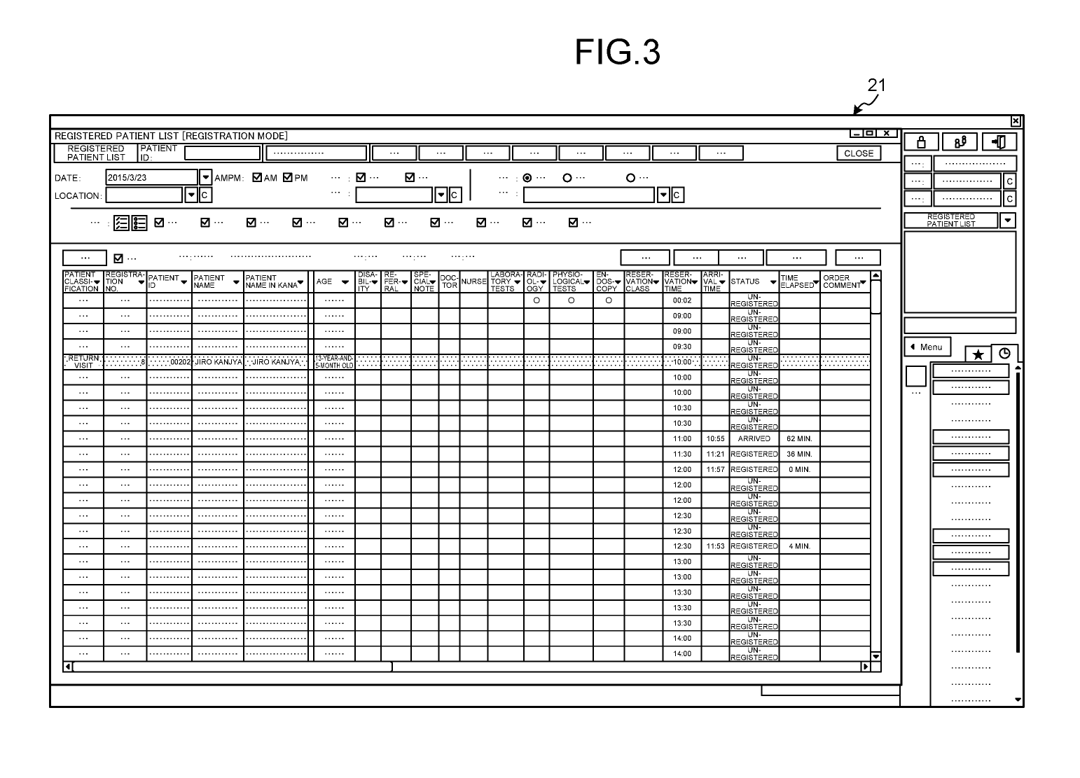

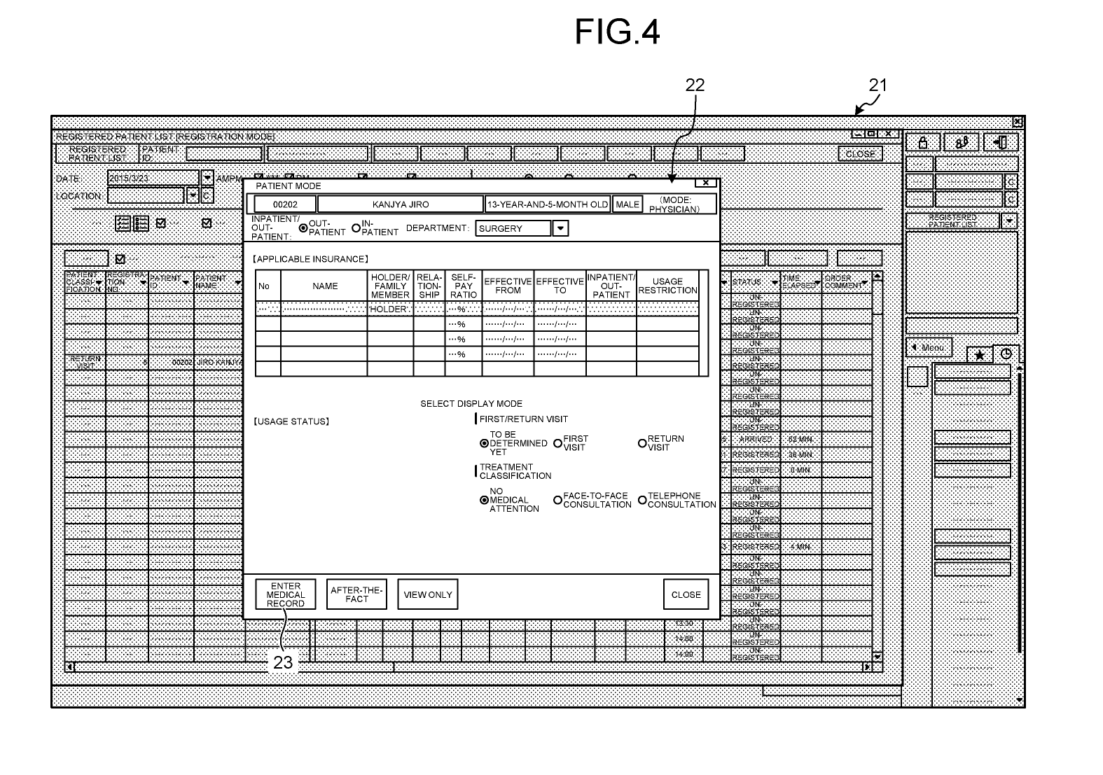

Explained now with reference to FIGS. 3 to 5 is an example in which a patient is selected from the patient list screen. FIG. 3 is a schematic illustrating an example of the patient list screen. FIG. 4 is a schematic illustrating an example of the confirmation screen. As illustrated in FIG. 3, a patient list screen 21 presents a list of patients. In response to a physician who is a user, for example, selecting “Jiro Kanjya” in the fifth line of the patient list screen 21, a confirmation screen 22 illustrated in FIG. 4 is displayed. The confirmation screen 22 is displayed in a manner superimposed over the patient list screen 21, for example. When a button 23 is pressed in the confirmation screen 22, the medical record of “Jiro Kanjya” is taken out from the medical record storage unit 121, and the medical record screen is displayed.

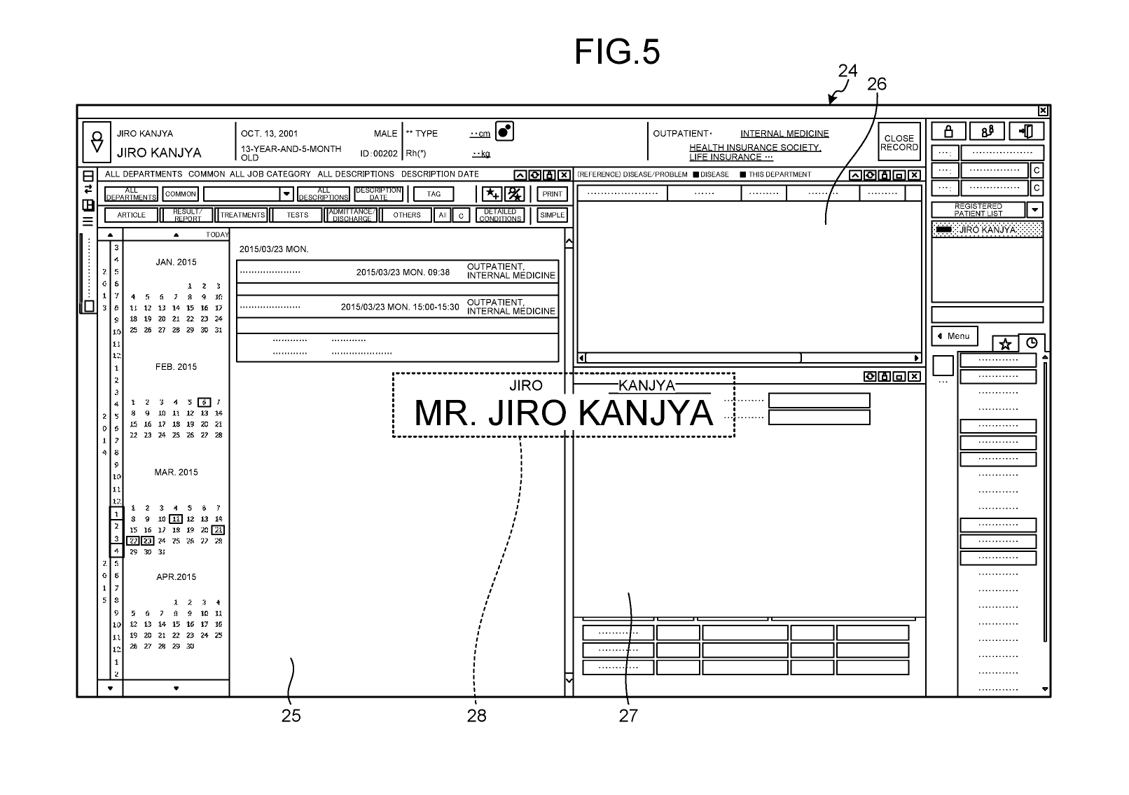

FIG. 5 is a schematic illustrating examples of the medical record screen and the name display screen. As illustrated in FIG. 5, displayed in a medical record screen 24 are a window 25 presenting a calendar and a piece of medical record content, and windows 26 and 27 presenting other pieces of medical record content. In the medical record screen 24, the window corresponding to the name display screen 28 is displayed in a superimposed manner. In other words, in the example illustrated in FIG. 5, the window of the name display screen 28 presenting the name of “Jiro Kanjya” is displayed superimposed over the window of the medical record screen 24 of “Jiro Kanjya”.

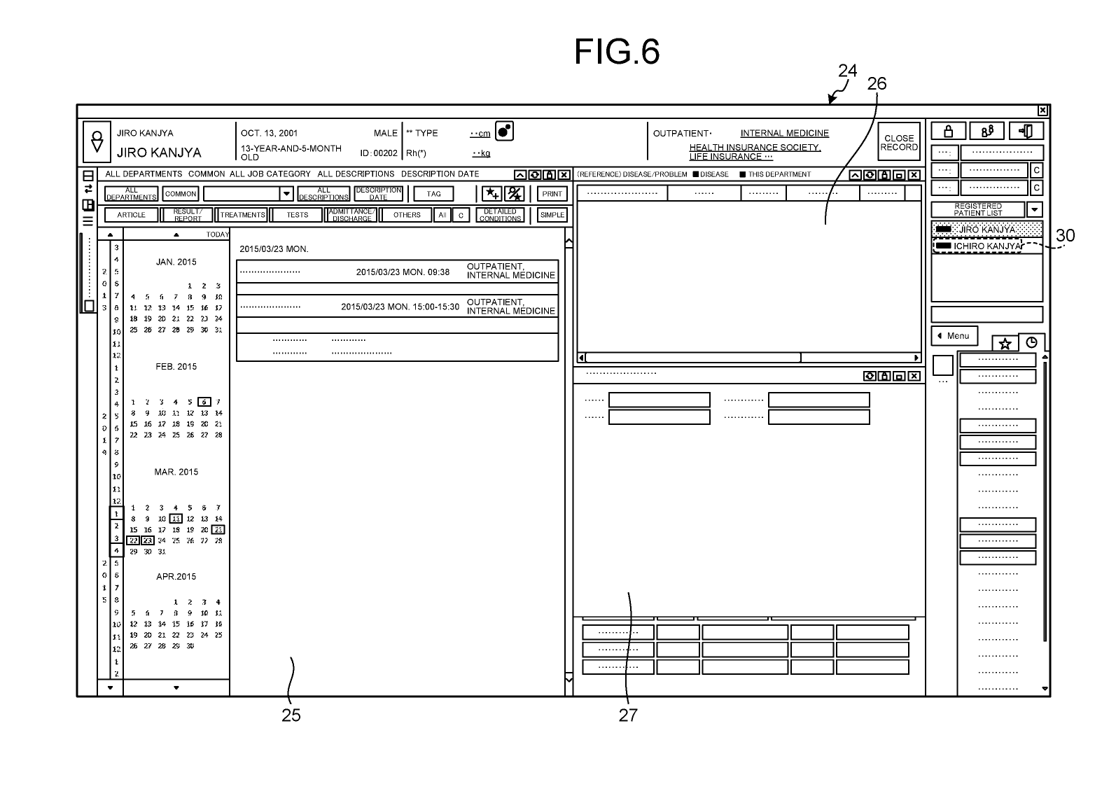

Explained now with reference to FIGS. 6 to 8 is an example in which a patient corresponding to an inactive window is selected from the medical records of a plurality of patients that are open. FIG. 6 is a schematic illustrating another example of the medical record screen. The exemplary medical record screen 24 illustrated in FIG. 6 is resultant of a physician performing an operation to the medical record of “Jiro Kanjya”, e.g., entering a piece of medical record content for the patient. Displayed in the medical record screen 24 are the window 25 presenting a calendar and a piece of medical record content of “Jiro Kanjya”, and the windows 26 and 27 presenting other pieces of medical record content of “Jiro Kanjya”, in the same manner as in FIG. 5. In the medical record screen 24 illustrated in FIG. 6, an item 30 indicating “Ichiro Kanjya”, who is another patient, is displayed in a registered patient list box representing that the medical records of these patients have been taken out from the medical record storage unit 121, and opened. In the medical record screen 24 illustrated in FIG. 6, in response to the physician who is a user, for example, selecting “Ichiro Kanjya” indicated in the item 30, the medical record displayed as an operable window is switched from the medical record of “Jiro Kanjya” to the medical record of “Ichiro Kanjya”.

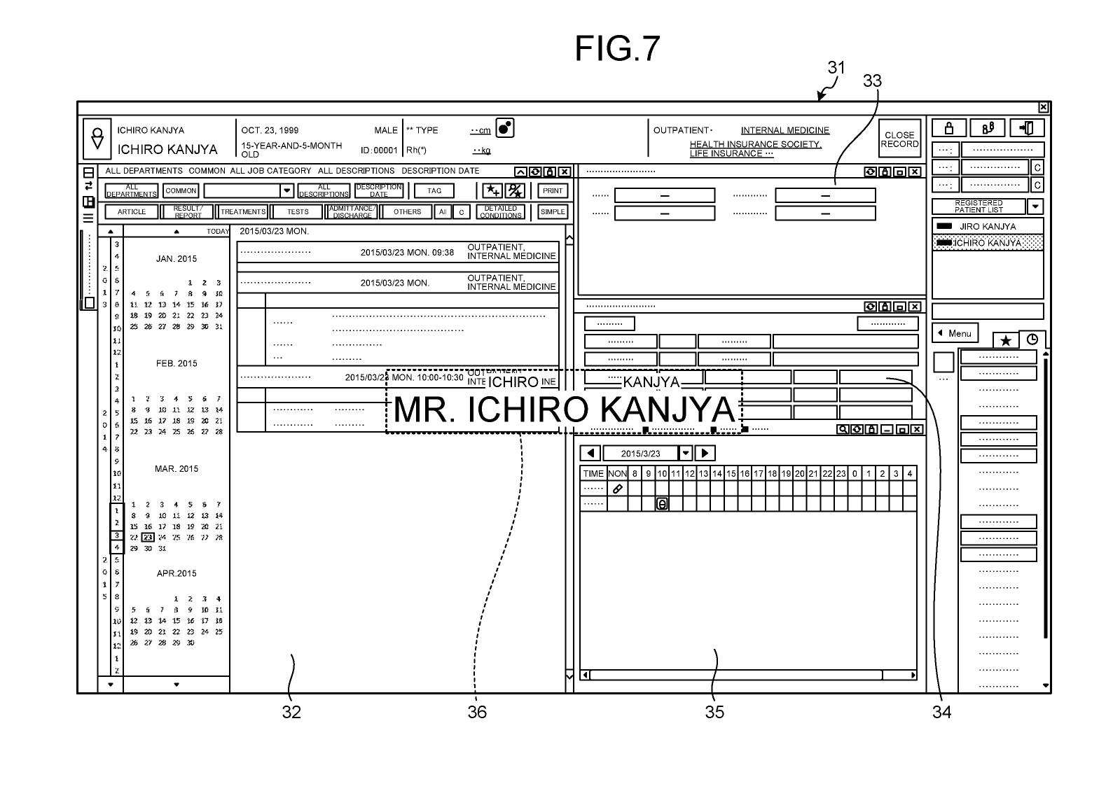

FIG. 7 is a schematic illustrating other examples of the medical record screen and the name display screen. Displayed in a medical record screen 31 illustrated in FIG. 7 are a window 32 presenting a calendar and a piece of medical record content of “Ichiro Kanjya”, and windows 33, 34, and 35 presenting some other pieces of medical record content of “Ichiro Kanjya”. A window of a name display screen 36 is also displayed in a manner superimposed over the medical record screen 31. In other words, in the example illustrated in FIG. 7, the window of the name display screen 36 presenting the name of “Ichiro Kanjya” is displayed in a manner superimposed over the window of the medical record screen 31 of “Ichiro Kanjya”.

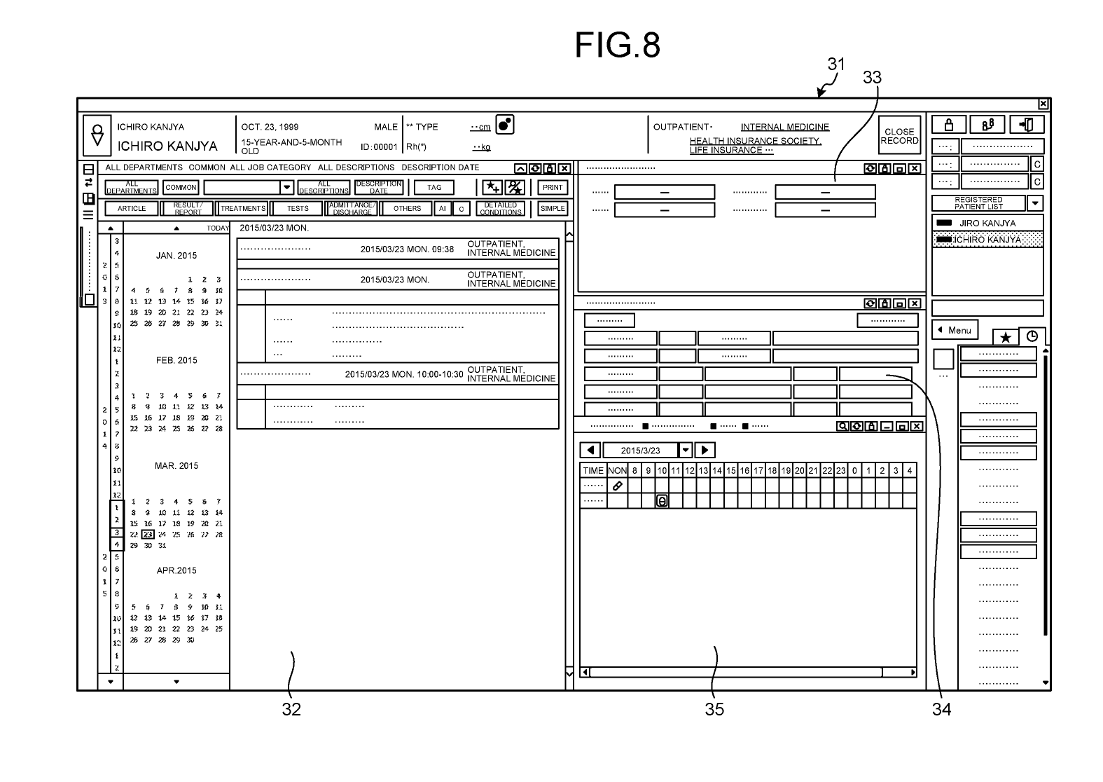

FIG. 8 is a schematic illustrating another example of the medical record screen. The medical record screen 31 illustrated in FIG. 8 is resultant of the predetermined time period elapsing after the medical record screen 31 and the name display screen 36 illustrated in FIG. 7 are displayed, and the physician making a mouse or keyboard operation, causing the name display screen 36 to disappear thereby. In other words, the medical record screen 31 illustrated in FIG. 8 is in a state in which the physician having checked the name information of “Ichiro Kanjya” presented in the name display screen 36 is now permitted to enter some description to the medical record of “Ichiro Kanjya” presented in the medical record screen 31. In the medical record screen 31, the name of the patient in the registered patient list box may be assigned with a color matched with the color of the frame of the window of the medical record screen so that the distinguishability is improved. In this manner, every time the medical record of a patient is made operable, the patient name information corresponding to the medical record is presented. Therefore, the information processing apparatus 100 can prevent erroneous input of medical record information belonging to a different patient.

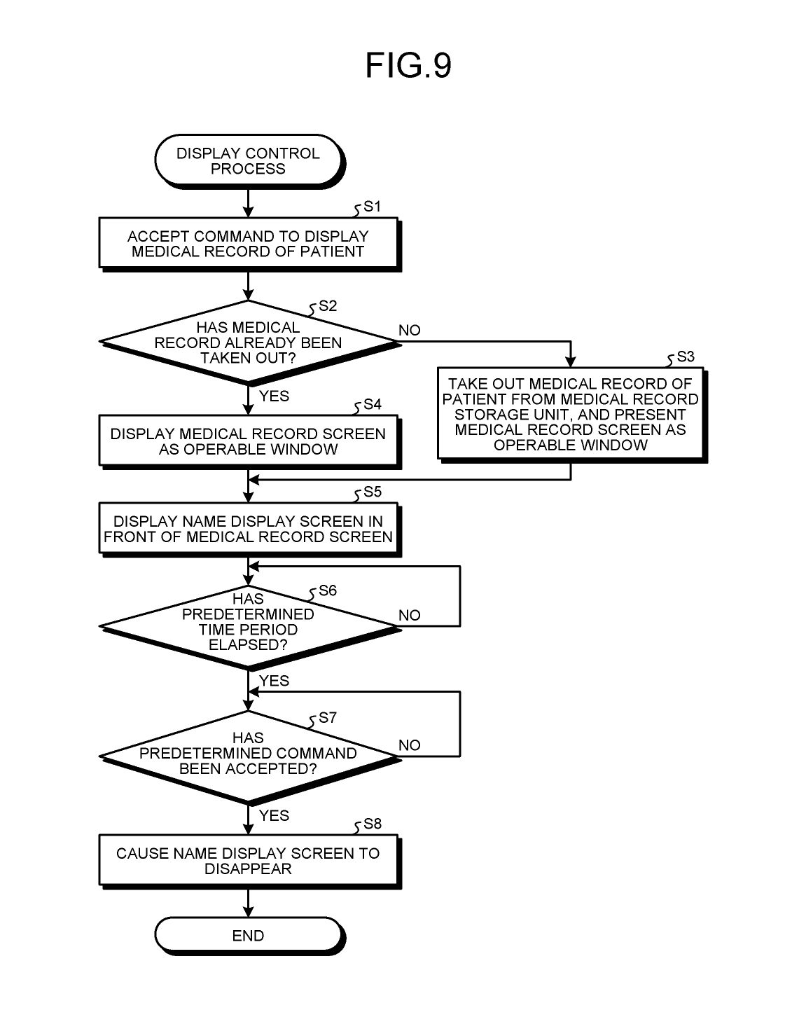

An operation of the electronic medical record system 1 according to the embodiment will now be explained. FIG. 9 is a flowchart illustrating an example of a display control process according to the embodiment.

The terminal device 10 is caused to transmit operation information for displaying a patient list to the information processing apparatus 100, as a result of a physician who is a user making an operation. When the operation information for displaying the patient list is received from the terminal device 10, the accepting unit 131 in the information processing apparatus 100 transmits the patient list screen to the terminal device 10. In response to a patient being selected from the patient list screen, the terminal device 10 transmits the command to present the medical record of the selected patient to the information processing apparatus 100. The accepting unit 131 in the information processing apparatus 100 then receives the command to present the medical record of the selected patient from the terminal device 10. When the command to present the medical record of the selected patient is received, the accepting unit 131 transmits a confirmation screen to the terminal device 10. When information of an operation for making a confirmation on the confirmation screen is received from the terminal device 10, the accepting unit 131 accepts the command to present the medical record of the selected patient.

When a patient corresponding to an inactive window is selected from the medical record screen while medical records of a plurality of respective patients are open, the terminal device 10 transmits the command to present the medical record of the selected patient to the information processing apparatus 100. The accepting unit 131 in the information processing apparatus 100 receives the command to present the medical record of the selected patient from the terminal device 10, and then accepts the received command to present the medical record of the selected patient (Step S1). The accepting unit 131 outputs the accepted command to present the medical record of the patient to the display control unit 132.

When the command to present the medical record of a patient is input from the accepting unit 131, the display control unit 132 determines whether the medical record of the patient for whom the command is accepted has already been taken out based on the patient ID included in the command to present the medical record (Step S2). If the medical record of the patient for whom the command is accepted has not been taken out yet (No at Step S2), the display control unit 132 takes out the medical record of the patient from the medical record storage unit 121, and generates a window of the medical record screen presenting the medical record information of the patient as an operable window. The display control unit 132 transmits the generated medical record screen to the terminal device 10, and presents the medical record screen on the display unit not illustrated (Step S3).

If the medical record of the patient for whom the command is accepted has already been taken out (YES at Step S2), the display control unit 132 updates the window of the medical record screen presenting the medical record information of the patient as an operable window. The display control unit 132 then transmits the updated medical record screen to the terminal device 10, and presents the medical record screen on the display unit not illustrated (Step S4).

The display control unit 132 also generates a name display screen presenting the name information of the patient corresponding to the operable medical record as a separate window, in front of the medical record screen. The display control unit 132 then transmits the generated name display screen to the terminal device 10, and presents the name display screen on the display unit not illustrated (Step S5). In other words, the display control unit 132 presents the name display screen by superimposing the name display screen over the medical record screen.

The display control unit 132 then determines whether the predetermined time period has elapsed from when the name display screen is displayed (Step S6). If the display control unit 132 determines that the predetermined time period has not elapsed yet from when the name display screen is displayed (No at Step S6), the display control unit 132 repeats the determination at Step S6 until the predetermined time period elapses. If the display control unit 132 determines that the predetermined time period has elapsed from when the name display screen is displayed (YES at Step S6), the display control unit 132 determines whether a predetermined command is received from the accepting unit 131. In other words, the display control unit 132 determines whether the accepting unit 131 has received the operation information from the terminal device 10 and accepted the predetermined command while the name display screen is being displayed on the terminal device 10 (Step S7). If the display control unit 132 determines that the accepting unit 131 has not accepted the predetermined command yet (No at Step S7), the display control unit 132 repeats the determination at Step S7 until the accepting unit 131 accepts the predetermined command. If the display control unit 132 determines that the accepting unit 131 has accepted the predetermined command (YES at Step S7), the display control unit 132 causes the name display screen to disappear by increasing the transparency of the screen (Step S8). Because the information processing apparatus 100 presents the patient name information clearly in the manner described above, the information processing apparatus 100 can prevent erroneous input of medical record information belonging to a different patient. Furthermore, because the information processing apparatus 100 presents the patient name information corresponding to the medical record every time the medical record of a patient is made operable, the information processing apparatus 100 can prevent erroneous input of medical record information belonging to a different patient.

In the manner described above, the information processing apparatus 100 accepts a command to present medical record information of a patient. Furthermore, the information processing apparatus 100 presents a window presenting the patient name information for a predetermined time period, in a layer positioned in front of the layer having the window presenting the medical record information of the patient, in the multi-window system. As a result, the information processing apparatus 100 can prevent erroneous input of medical record information belonging to a different patient.

Furthermore, the information processing apparatus 100 performs, for the window presenting the patient name information for a predetermined time period, display control for decreasing the transparency of the window, and then starting to increase the transparency after the predetermined transparency is reached. As a result, the possibility of the physician missing out the name information can be reduced.

Furthermore, the information processing apparatus 100 performs, for the window presenting the patient name information for a predetermined time period, display control for keeping the patient name information displayed until the predetermined command is accepted. As a result, the possibility of the physician missing out the name information can be reduced.

Furthermore, the information processing apparatus 100 performs the control for displaying the window presenting the patient name information for a predetermined time period in a manner superimposed over the window presenting the medical record information of the patient. As a result, even when the window presenting the medicalrecord information of the patient has already been displayed once, the patient name information corresponding to that medical record is displayed again, so that a physician can check the patient name information again.

In the embodiment described above, the patient name information is displayed in response to an acceptance of the command to present the medical record information, but the present invention is not limited thereto. For example, the information processing apparatus 100 may display the patient name information when a physician leaves his/her seat for 5 minutes or so to do some other task, that is, when the information processing apparatus 100 is not operated for a predetermined time period, while the physician is examining a patient. In this manner, the physician can recognize the medical record information of which patient is being displayed when the physician returns his/her seat after the leave.

Furthermore, in the embodiment described above, when a patient is selected from the patient list screen, the confirmation screen is displayed in response. However, the present invention is not limited thereto. For example, the medical record screen and the name display screen of a patient may be displayed immediately after the patient is selected from the patient list screen.

Furthermore, the elements included in each of the units illustrated in the drawings do not necessarily need to be physically configured in the manner illustrated. In other words, specific configurations in which each of the units is distributed or integrated are not limited to those illustrated in the drawings, and the whole or a part of each of the units may be distributed or integrated functionally or physically in any units depending on various loads or utilization. For example, the accepting unit 131 may be divided into a first receiving unit for accepting the command to present the medical record, and a second receiving unit for accepting the operation information in the name display screen.

Furthermore, the whole or a part of various processing functions executed on each apparatus may be executed by a CPU (or a microcomputer such as an MPU or a micro-controller unit (MCU)). Furthermore, the whole or a part of the various processing functions may be implemented as a computer program parsed and executed by a CPU (or a microcomputer such as an MPU or an MCU), or as a piece of hardware implementing a hardware logic.

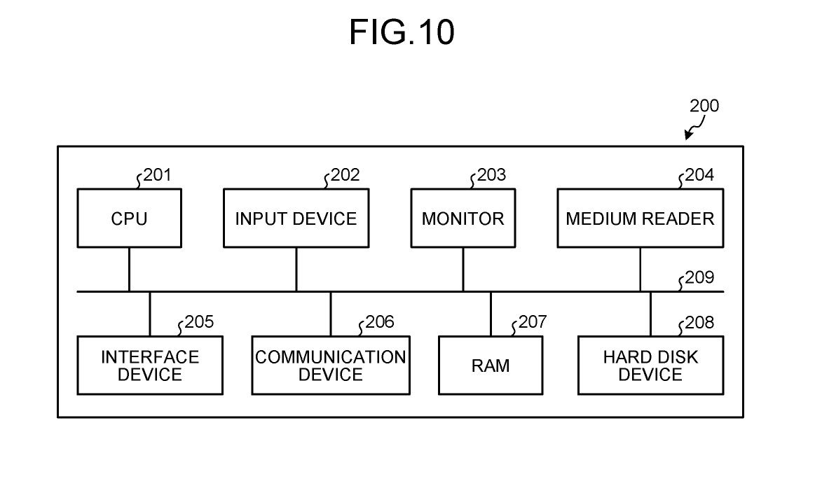

The various processes explained in the embodiment can be implemented by causing a computer to execute a computer program having been prepared in advance. Explained now is an example of such a computer executing a computer program having the same functions as those of the information processing apparatus 100 explained in the embodiment. FIG. 10 is a schematic illustrating an example of the computer executing the display control program.

As illustrated in FIG. 10, this computer 200 includes a CPU 201 executing various operations, an input device 202 that accepts data inputs, and a monitor 203. The computer 200 also includes a medium reader 204 that reads a computer program and the like from a storage medium, an interface device 205 for connecting with various devices, and a communication device 206 for connecting with other information processing apparatuses and the like over the wire or wirelessly. The computer 200 also includes a RAM 207 for temporally storing therein various types of information, and a hard disk device 208. These devices 201 to 208 are connected to a bus 209.

The hard disk device 208 stores therein a display control program having the same functions as those of accepting unit 131 and the display control unit 132 illustrated in FIG. 1. The hard disk device 208 also stores therein the medical record storage unit 121, and various types of data for implementing the display control program. The input device 202 receives inputs of various types of information such as administrative information from the administrator of the computer 200, for example. The monitor 203 presents various screens, such as a screen for administrative information, to the administrator of the computer 200, for example. The interface device 205 is connected to a printer, for example. The communication device 206 has the same function as that of the communicating unit 110 illustrated in FIG. 1, for example, and is connected to the network N and exchanges various types of information with the terminal device 10.

The CPU 201 performs various processes by reading each computer program stored in the hard disk device 208, loading the computer program onto the RAM 207, and executing the computer program. These computer programs can also cause the computer 200 to function as the accepting unit 131 and the display control unit 132 illustrated in FIG. 1.

The display control program does not necessarily need to be stored in the hard disk device 208. For example, a computer program stored in a storage medium that is readable by the computer 200 may be read and executed by the computer 200. Examples of the storage medium that is readable by the computer 200 include a portable recording medium such as a compact disc read-only memory (CD-ROM), a digital versatile disc (DVD), a universal serial bus (USB) memory, a semiconductor memory such as a flash memory, and a hard disk drive. The display control program may also be stored in a device connected to a public circuit, the Internet, or a local area network (LAN), for example, and the computer 200 may read the display control program from the device, and execute the display control program.

The computer-readable recording medium, the display control method, and the information processing apparatus according to the present invention can prevent erroneous input to a piece of medical record information belonging to a different patient.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a display control program that causes a computer to execute a process comprising:
accepting a command to present medical record information of a patient; and
presenting name information of the patient in a window for a predetermined time period, in a layer positioned in front of a layer having a window presenting the medical record information of the patient, in a multi-window system.

2. The computer-readable recording medium according to claim 1, wherein the process further includes performing display control so that transparency of the window presenting the name information of the patient for a predetermined time period is decreased, and then increased after a predetermined transparency is reached.

3. The computer-readable recording medium according to claim 1, wherein the process further includes performing display control so that the window presenting the name information of the patient for a predetermined time period keeps the name information of the patient displayed until a predetermined command is accepted.

4. The computer-readable recording medium according to claim 1, wherein the process further includes performing display control so that the window presenting the name information of the patient for a predetermined time period is displayed in a manner superimposed over the window presenting the medical record information of the patient.

5. A display control method comprising:
accepting a command to present medical record information of a patient, by a processor; and
presenting name information of the patient in a window for a predetermined time period, in a layer positioned in front of a layer having a window presenting the medical record information of the patient, in a multi-window system, by the processor.

6. The display control method according to claim 5, further including performing display control so that transparency of the window presenting the name information of the patient for a predetermined time period is decreased, and then increased after a predetermined transparency is reached, by the processor.

7. The display control method according to claim 5, further including performing display control so that the window presenting the name information of the patient for a predetermined time period keeps the name information of the patient displayed until a predetermined command is accepted, by the processor.

8. The display control method according to claim 5, further including performing display control so that the window presenting the name information of the patient for a predetermined time period is displayed in a manner superimposed over the window presenting the medical record information of the patient, by the processor.

9. An information processing apparatus comprising:
a processor that executes a process including:
accepting a command to present medical record information of a patient; and
presenting name information of the patient in a window for a predetermined time period, in a layer positioned in front of a layer having a window presenting the medical record information of the patient, in a multi-window system.

10. The information processing apparatus according to claim 9, wherein the process further includes performing display control so that transparency of the window presenting the name information of the patient for a predetermined time period is decreased, and then increased after a predetermined transparency is reached.

11. The information processing apparatus according to claim 9, wherein the process further includes performing display control so that the window presenting the name information of the patient for a predetermined time period keeps the name information of the patient displayed until a predetermined command is accepted.

12. The information processing apparatus according to claim 9, wherein the process further includes performing display control so that the window presenting the name information of the patient for a predetermined time period is displayed in a manner superimposed over the window presenting the medical record information of the patient.
